(19) United States
(12) Patent Application Publication
(10) Pub. No.: US 2023/0387578 A1
(43) Pub. Date: Nov. 30, 2023

(54) Antenna

(71) Applicant: Tyco Electronics Japan G.K., Kawasaki-shi (JP)

(72) Inventor: Yohei Sakurai, Kawasaki-shi (JP)

(73) Assignee: Tyco Electronics Japan G.K., Kawasaki-shi (JP)

(21) Appl. No.: 18/332,124

(22) Filed: Jun. 9, 2023

Related U.S. Application Data
(63) Continuation of application No. PCT/JP2021/045152, filed on Dec. 8, 2021.

(30) Foreign Application Priority Data
Dec. 10, 2020 (JP) 2020205163

(51) Int. Cl. H01Q 1/36; H01Q 1/12; H01Q 1/48

(52) U.S. Cl. CPC H01Q 1/36; H01Q 1/12; H01Q 1/48

(57) ABSTRACT

An antenna includes a grounding portion, a feeding portion, a first extension portion extending from the feeding portion to a leading end portion of the antenna, and a second extension portion extending from the leading end portion to the grounding portion. The first extension portion, the leading end portion, and the second extension portion have a steric coupling to one another.

### CROSS-REFERENCE TO RELATED APPLICATIONS

This application is a continuation of PCT International Application No. PCT/JP2021/045152, filed on Dec. 8, 2021, which claims priority under 35 U.S.C. § 119 to Japanese Patent Application No. 2020-205163, filed on Dec. 10, 2020.

### FIELD OF THE INVENTION

The present invention relates to antennas. More specifically, the present invention relates to a monopole antenna.

### BACKGROUND

Antennas of various shapes have been used in information communication devices configured to send and receive information in the form of radio signals (see, for example, Japanese Patent Application No. 2010-259048A).

Conventional antenna have problems to be overcome. For example, as shown in FIGS. 17A-17D, antennas of various shapes have been known in this technical field. FIG. 17A shows a straight antenna. FIG. 17B shows a bent antenna having its leading end portion bent. FIG. 17C shows a vortical antenna having its leading end portion wound. All of the antennas illustrated in FIGS. 17A to 17C are called “monopole antennas” (¼λ). FIG. 17D shows a folded-back (switchback) monopole antenna spreading two-dimensionally in the shape of a plate or a plane (½λ).

For example, Japanese Patent Application No. 2010-259048A discloses, as a plate-like antenna, an antenna having, on an oblique plane, a feeding point to which a coaxial cable is connected (see FIG. 4 of Japanese Patent Application No. 2010-259048A).

In this technical field, there have been demands for miniaturization of antennas. However, the antenna disclosed in Japanese Patent Application No. 2010-259048A, in which the coaxial cable is connected to the feeding point by soldering or other connections, faces a physical limit on a reduction in size. Further, the antenna disclosed in Japanese Patent Application No. 2010-259048A, in which the coaxial cable is connected to the feeding point, suffers alteration and destabilization of antenna characteristics due to a leak current from the coaxial cable. The antenna may also suffer alteration and destabilization of antenna characteristics due to adhesion of solder. It should be noted that the antenna disclosed in Japanese Patent Application No. 2010-259048A also undesirably has its impedance adjustment area confined to a narrow band and held dependent on the ground plate distance.

### SUMMARY

An antenna includes a grounding portion, a feeding portion, a first extension portion extending from the feeding portion to a leading end portion of the antenna, and a second extension portion extending from the leading end portion to the grounding portion. The first extension portion, the leading end portion, and the second extension portion have a steric coupling to one another.

### BRIEF DESCRIPTION OF THE DRAWINGS

The invention will now be described by way of example with reference to the accompanying Figures, of which:

FIG. 1 is a schematic isometric view schematically showing an antenna according to one embodiment of the present disclosure as seen from the side of a feeing portion;

FIG. 2 is a schematic isometric view schematically showing an antenna according to one embodiment of the present disclosure as seen from the side of a leading end portion;

FIGS. 3A-3F are schematic views showing an antenna from a plurality of different sides according to one embodiment of the present disclosure;

FIG. 4 is a schematic isometric view schematically showing an antenna according to one embodiment of the present disclosure together with a supporter as seen from the side of a feeding portion;

FIG. 5 is a schematic isometric view schematically showing an antenna according to one embodiment of the present disclosure together with a supporter as seen from the side of a leading end portion;

FIGS. 6A-6F are schematic views showing an antenna from a plurality of different sides according to one embodiment of the present disclosure together with a supporter;

FIG. 7 is a schematic isometric view schematically showing an antenna according to another embodiment of the present disclosure together with a supporter as seen from the side of a feeding portion;

FIG. 8 is a schematic isometric view schematically showing an antenna according to another embodiment of the present disclosure together with a supporter as seen from the side of a leading end portion;

FIG. 9 is a schematic isometric view schematically showing an antenna according to another embodiment of the present disclosure together with a supporter as seen from the side of a feeding portion;

FIG. 10 schematically shows an antenna according to another embodiment of the present disclosure together with a supporter as seen from the side of a leading end portion;

FIGS. 11A-11D show the shape and antenna characteristics of a monopole antenna fabricated in Example 1;

FIGS. 12A-12D show the shape and antenna characteristics of a straight monopole antenna fabricated in Comparative Example 1;

FIGS. 13A-13D show the shape and antenna characteristics of a bent monopole antenna fabricated in Comparative Example 2;

FIGS. 14A-14D show the shape and antenna characteristics of a vortical monopole antenna fabricated in Comparative Example 3;

FIGS. 15A-15D shows the shape and antenna characteristics of a folded-back monopole antenna fabricated in Comparative Example 4;

FIG. 16 shows relationships between the frequencies and impedances of the antennas fabricated in Example 1 and Comparative Examples 1 to 4; and

FIGS. 17A-17D illustrates schematic views schematically showing conventional antennas.

### DETAILED DESCRIPTION OF THE EMBODIMENT(S)

The present disclosure relates to an antenna having at least one grounding portion and a feeding portion, the antenna including a first extension portion extending from the feeding portion to a leading end portion of the antenna and a second extension portion extending from the leading end portion to the grounding portion, wherein the first extension portion, the leading end portion, and the second extension portion have a steric coupling to one another. Such an antenna is hereinafter referred to as “antenna of the present disclosure”.

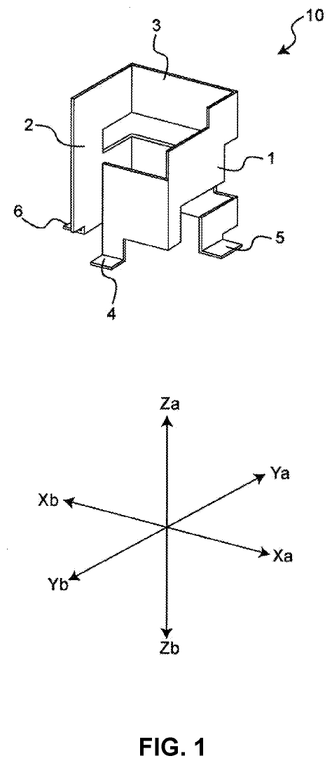

For example, in an antenna 10 according to one embodiment of the present disclosure shown in FIG. 1, a first extension portion 1 extending or spreading from a feeding portion 4 to a leading end portion 3, the leading end portion 3 of the antenna, and a second extension portion 2 extending or spreading from the leading end portion 3 to a grounding portion 5 are sterically configured by being successively coupled to one another. Therefore, the antenna of the present disclosure is sterically compact and can be further miniaturized.

By having such a steric configuration, the antenna of the present disclosure can have further stabilized antenna characteristics.

The term “antenna characteristics” in the present disclosure means the characteristics of an antenna in general and, specifically, means characteristics such as a radiating pattern such as a directivity index and an impedance.

The term “stabilization” of the antenna characteristics in the present disclosure means, in general, that the antenna characteristics do not greatly fluctuate. For example, in a case where the antenna characteristics are a radiating pattern, the stabilization of the antenna characteristics means that the antenna is non-directional, and in particular, in a case where the antenna characteristics are a directivity index, the stabilization of the antenna characteristics means that the antenna has a radiating pattern whose outer shape is close to a perfect circle in an X-Y plane.

Further, in a case where the antenna characteristics are an impedance, the stabilization of the antenna characteristics means, for example, that the antenna stably exhibits a targeted impedance (e.g. an impedance higher than or equal to 25Ω and lower than or equal to 55Ω, in another embodiment higher than or equal to 45Ω and lower than or equal to 55Ω) in a desired frequency band or a required frequency band. In the antenna of the present disclosure, a band including the targeted impedance can be formed over a wide frequency band (e.g. lower than or equal to 13 GHz, in an embodiment higher than or equal to 6 GHz and lower than or equal to 9 GHz).

The stabilization of such antenna characteristics, particularly the stabilization of impedance fluctuations, can be further improved, for example, by the self-standing property, shape stability, or other properties of the antenna.

Stabilizing the antenna characteristics in this way makes it possible to stably adjust an impedance in a wide frequency band (e.g. lower than or equal to 13 GHz, in an embodiment higher than or equal to 6 GHz and lower than or equal to 9 GHz). In other words, doing so makes it possible to provide an antenna whose impedance adjustment area is not confined to a narrow band.

Furthermore, by being provided with a plurality of grounding portions, the antenna of the present disclosure can achieve multi-resonation and can cope with a wider band, i.e. a broad band.

For example, as shown in FIG. 1, the antenna of the present disclosure can include a feeding portion or feeding point 4 and a plurality of grounding portions or grounding points 5, 6 both of which can be extended as legs. By having such a feeding portion and such grounding portions, the antenna of the present disclosure can be loaded or mounted, for example, on a substrate of a computer or other electronic machines, especially on a printed circuit board. Therefore, the antenna of the present disclosure does not require use of a coaxial cable or other components and can be more compactly designed.

By having such a configuration, the antenna of the present disclosure can have a smaller size and further stabilized antenna characteristics.

It should be noted that the antenna of the present disclosure is not limited to the illustrated embodiments.

The term “antenna” in the present disclosure means a component, an apparatus, or a device capable of mutual conversion of an electrical current into radio waves or electromagnetic waves and vice versa. In the present disclosure, the antenna be a monopole antenna. By being a monopole antenna, the antenna can be manufactured at a lower cost.

In an embodiment, the antenna of the present disclosure can be composed of a conductor. Examples of the conductor include a metal and/or an alloy. Examples of metal elements that may be contained in the metal and/or the alloy include copper (Cu), aluminum (Al), iron (Fe), and zinc (Zn). In an embodiment, the conductor can be made of at least one substance selected from the group consisting of copper, aluminum, stainless steel, and brass. In an embodiment, the antenna of the present disclosure be manufactured from a brass material.

In a case where the antenna of the present disclosure is composed of a material such as the metal and/or the alloy, the antenna may further include a plated layer or a surface-treated layer. The plated layer or the surface-treated layer can contain an element such as chromium or nickel.

The antenna of the present disclosure may be composed of a ceramic or other materials. As the ceramic, a high dielectric ceramic is preferred. For example, a dielectric ceramic or other substances that can be used in a chip antenna can be used without particular limit. The antenna may be composed of a composite material based on a metal and a ceramic.

In the present disclosure, the members (such as the feeding portion, the grounding portions, the extension portions, and/or the leading end portion, or other members) of the antenna each be in the shape of a plate and be sterically combined with one another. The members may be bent or folded back as needed. The thicknesses of the members are not limited to any particular values, and may for example be smaller than or equal to 1 mm, smaller than or equal to mm, greater than or equal to 0.1 mm and smaller than or equal to 0.4 mm. The thicknesses of the members may or may not be uniform.

The term “feeding portion” of the antenna in the present disclosure means a point at which electricity or electrical energy may be fed from an external structure. The feeding portion is not limited to any particular shape. The feeding portion may be in the shape of a plate (see FIG. 1). The feeding portion may be connected to a feeder or power supply line of, for example, a substrate, more specifically a printed circuit board. The feeding portion may have, at a portion thereof that is in contact with the substrate, a shape conforming to a surface shape of the substrate. The feeding portion may be in the shape of a single plate or may not be in the shape of a plate.

The “shape of a plate” in the present disclosure is not limited to the shape of a completely flat plate but may at least partially include a curved portion, a bent portion, and/or an inclined portion.

The term “grounding portions” of the antenna in the present disclosure means points or portions that may form the ground (GND) by making contact with an external structure. The grounding portions are each not limited to any particular shape. The ground portions may or may not be partially extended from the extension portions. In a case where the ground portions are extended from the extension portions, the grounding portions may each be in the shape of a plate (see FIG. 1). The grounding portions may be connected to a GND layer or GND wire of, for example, a substrate, more specifically a printed circuit board. The grounding portions may have, at portions thereof that are in contact with the substrate, shapes conforming to the surface shape of the substrate. Each of the grounding portions may be in the shape of a single plate or may not be in the shape of a plate.

The grounding portions may be provided at any edges of the extension portions. The grounding portions may be provided at lower or bottom edges of the extension portions. In that case, it is preferable that the grounding portions provided at the edges of the extension portions be equal in height to the feeding portion.

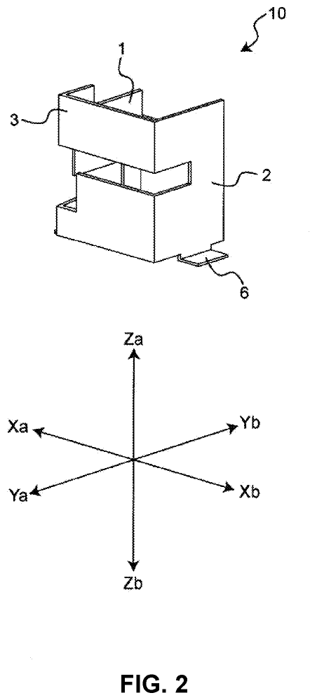

The term “leading end portion” of the antenna in the present disclosure means a portion or area in the antenna of the present disclosure that may be at the highest position above the feeding portion. In other words, the term “leading end portion” means a portion or area that may be at the highest position in the direction of the height of the antenna (e.g. in a Za direction shown in FIG. 1) above the feeding portion. The leading end portion is not limited to a particular shape. The leading end portion may be in the shape of a plate (see FIGS. 1 and 2).

In the present embodiment, the “leading end portion” is not limited to a particular height, i.e. not limited to a particular distance or position from the feeding portion. In other words, the “leading end portion” is not limited to a particular distance (hereinafter referred to as “ground plate distance) from a “ground plate” to the “leading end portion”. Based on such a configuration, the present invention can provide an antenna that is independent of the ground plate distance.

The leading end portion may have at least two connected portions to one of which the first extension portion is coupled or joined and to the other of which the second extension portion is coupled or joined (see FIGS. 1 and 2).

The term “extension portions” of the antenna in the present disclosure means portions that may spread to be coupled or joined to the leading end portion of the antenna, such as the connected portions of the leading end portion of the antenna.

The antenna of the present disclosure may include at least two extension portions:
(1) A portion or area that extends from the feeding portion of the antenna to the leading end portion of the antenna is referred to as “first extension portion” or “first portion”. In other words, a portion or area that may spread between the feeding portion of the antenna and the leading end portion of the antenna is referred to as “first extension portion” or “first portion”.
(2) A portion or area that extends from the leading end portion of the antenna to a grounding portion of the antenna is referred to as “second extension portion” or “second portion”. In other words, a portion or area that may spread between the leading end portion of the antenna and a grounding portion of the antenna is referred to as “second extension portion” or “second portion”.

In the present disclosure, the statement that the “first extension portion”, the “leading end portion”, and the “second extension portion” of the antenna have a steric coupling to one another means that the “first extension portion”, the “leading end portion”, and the “second extension portion” are coupled or joined in a non-planar fashion. In other words, the statement means that the “first extension portion”, the “leading end portion”, and the “second extension portion” are coupled or joined in a non-two-dimensional fashion.

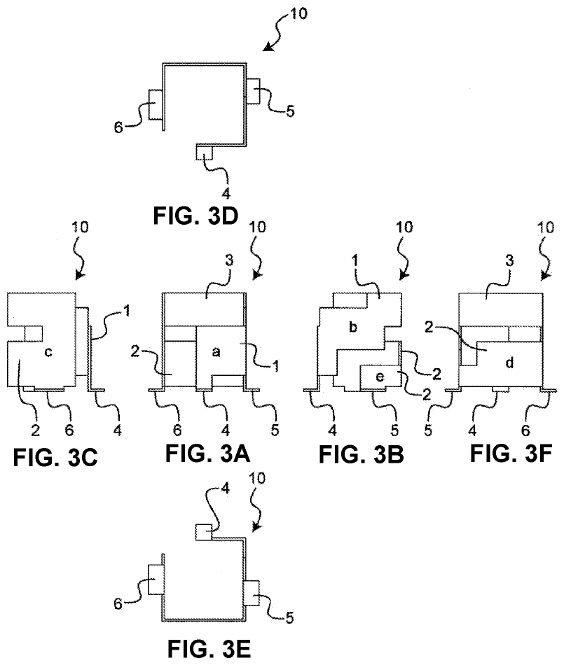

In an embodiment, the antenna has, as its steric shape, an overall shape (excluding the feeding portion and the grounding portions) that is a box shape such as a cube or a cuboid or a substantially columnar shape such as a quadrangular prism (see FIG. 3). In other words, the antenna of the present disclosure have a substantially quadrangular shape in a top view. The term “substantially quadrangular shape” typically means a shape having four corners. Accordingly, the term “substantially quadrangular shape” may encompass a quadrangular shape a regular square or rectangle having 90-degree angles at all of the four corners and a shape such as a diamond or a trapezoid. The corners may be rounded.

The antenna may have, as its steric shape, an overall shape (excluding the feeding portion and the grounding portions) that is a triangular prismatic shape. In other words, the antenna of the present disclosure may have a substantially triangular shape in a top view (not illustrated). In the present disclosure, the term “substantially triangular shape” typically means a shape that can be recognized as a triangle having three corners. Accordingly, the term “substantially triangular shape” may encompass a shape having rounded corners.

The antenna may have, as its steric shape, an overall shape (excluding the feeding portion and the grounding portions) that is a polygonal columnar shape. In other words, the antenna of the present disclosure may have a substantially polygonal shape in a top view. In the present disclosure, the term “substantially polygonal shape” typically means a shape that can be recognized as a polygon having five or more corners. Accordingly, the term “substantially polygonal shape” may encompass a shape having rounded corners. Further, the “substantially polygonal shape” may be a geometric shape such as a substantially cross shape or star shape in a top view.

The antenna may have, as its steric shape, an overall shape (excluding the feeding portion and the grounding portions) that is a cylindrical columnar shape. In other words, the antenna of the present disclosure may have a substantially circular shape in a top view. In the present disclosure, the term “substantially circular shape” typically means a shape that can be recognized as a circle. Accordingly, the “substantially circular shape” may encompass a shape such as an ellipse. In addition, the “substantially circular shape” may be a shape partially having a substantially circular shape in a top view, such as a keyhole shape, or a shape composed of a plurality of substantially circular shapes.

Such a steric configuration may or may not be a line-symmetric or point-symmetric shape in a top view. Such a steric and three-dimensional configuration makes it possible to attain multi-resonation of the antenna. The multi-resonation of the antenna further stabilizes the antenna characteristics and makes it possible to attain a wide band of resonant frequencies.

In the antenna of the present disclosure, the steric coupling of the “first extension portion”, the “leading end portion”, and the “second extension portion” may be such that one of the first extension portion and the second extension portion is disposed at one of the two connected portions of the leading end portion of the antenna and the other of the first extension portion and the second extension portion is disposed at the other of the two connected portions of the leading end portion of the antenna. In other words, the leading end portion of the antenna may be disposed between the first extension portion and the second extension portion with the connected portions interposed therebetween.

The steric coupling of the “first extension portion”, the “leading end portion”, and the “second extension portion” may include a “winding”. In other words, the “first extension portion”, the “leading end portion”, and the “second extension portion” may be sterically coupled to one another by a “winding”.

The term “winding” in the present disclosure means that the “first extension portion”, the “leading end portion”, and the “second extension portion” are successively coupled and turn. As illustrated, the “winding” encompasses, for example, a coupling of the “first extension portion”, the “leading end portion”, and the “second extension portion” by a bending with a substantially quadrangular shape in a top view (see FIG. 3) and a coupling of the “first extension portion”, the “leading end portion”, and the “second extension portion” by a curving with a substantially circular shape in a top view (not illustrated). In other words, more specifically, the “winding” encompasses, for example, a spiral or vortical turning made by a bending or a curving.

The term “spiral” or “vortical” in the present disclosure means a turning that entails a vertical (Z-axis) movement or displacement.

For example, in an antenna 10 according to one embodiment of the present disclosure shown in FIG. 1, a first extension portion 1 and a second extension portion 2 are successively coupled to two connected portions of a plate-like leading end portion 3 having a rectangular shape, i.e. two short sides, by a bending.

The first extension portion 1 may be bent only once at an angle of approximately 90 degrees between the feeding portion 4 and the leading end portion 3. In other words, the first extension portion 1 may have a substantially L shape in a top view. Accordingly, the first extension portion 1 can be combined with the leading end portion 3 to form a substantially U shape in a top view.

For example, the second extension portion 2 is bent twice at angles of approximately 90 degrees between the grounding portion 5 and the leading end portion 3. In other words, the second extension portion 2 has a substantially U shape in a top view. Accordingly, the second extension portion 2 can be combined with the leading end portion 3 to similarly form a substantially U shape in a top view.

Given this situation, in the illustrated aspect, the first extension portion 1 and the second extension portion 2, together with the leading end portion 3, may be successively coupled to each other in a spiral or vortical manner by a “winding”.

The steric coupling of the “first extension portion”, the “leading end portion”, and the “second extension portion” may include a “folding back”.

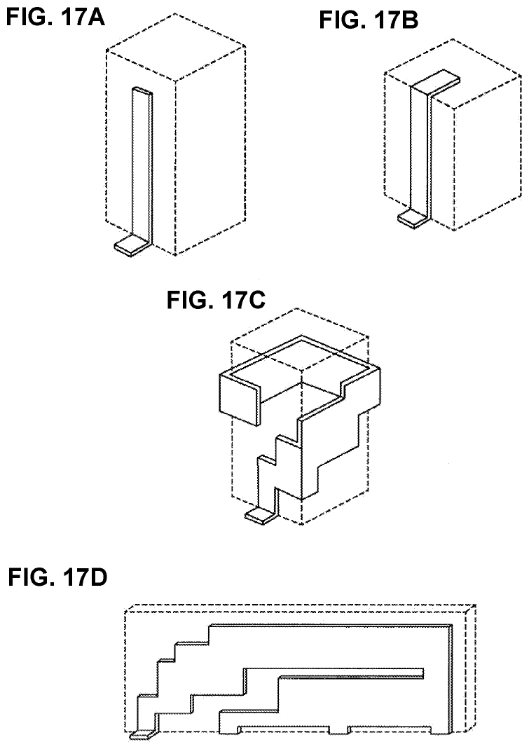

The term “folding back” in the present disclosure means that when seen from the side or seen in a development, the antenna of the present disclosure extends lengthwise (along an X axis or a Y axis), further extends heightwise (along the Z axis) (i.e. extends upward or downward), then makes a U-turn, i.e. a “folding back” and extends backward lengthwise. The “folding back” in the present disclosure is also called “switchback” (see FIG. 17D).

There is no particular limit on the number of folding backs that can be included in the steric coupling of the present disclosure. A folding back may be included in a coupling or combination of the leading end portion and the first extension portion. Alternatively, a folding back may be included in a coupling or combination of the leading end portion and the second extension portion.

For example, in the aspect shown in FIG. 1, a “folding back” is included in a coupling or combination of the leading end portion 3 and the second extension portion 2 of the antenna 10.

By including such a “winding” and/or “folding back”, the antenna of the present disclosure can be designed to be three-dimensionally compact and smaller.

In the antenna of the present disclosure, particularly the steric coupling of the “first extension portion”, the “leading end portion”, and the “second extension portion”, may include both a “winding” and a “folding back”. The including of a “winding” by the steric coupling allows the “first extension portion”, the “leading end portion”, and the “second extension portion” to turn in a top view and, furthermore, allows them to turn while making a vertical movement or displacement (along the Z axis, more specifically in the Za direction and/or a Zb direction). In other words, a spiral or vortical turning can be made. Furthermore, the inclusion of a “folding back” allows them to make a vertical movement or displacement (along the Z axis, more specifically in the Za direction and/or the Zb direction) while turning and meander along the X axis and/or the Y axis. In other words, they can meander while making a spiral or vortical turning.

By including such a “winding” and/or “folding back”, the antenna of the present disclosure can have a greater distance between the feeding portion and a grounding portion and further stabilized antenna characteristics.

The antenna of the present disclosure may include a plurality of grounding portions. By including a plurality of grounding portions, the antenna of the present disclosure can achieve multi-resonation and have further stabilized antenna characteristics. Providing such a plurality of grounding portions makes it possible to attain a more stable broad band.

In the antenna of the present disclosure, the feeding portion and the grounding portions may lie in the same plane. For example, as shown in FIG. 1, the feeding portion 4 is extended at an angle of approximately 90 degrees outward from the first extension portion 1, and the grounding portions 5, 6 are each extended at an angle of approximately 90 degrees outward from the second extension portion 2. The feeding portion 4 and the grounding portions 5, 6 are each preferably in the shape of a plate, and lie in the same plane. By thus including the feeding portion 4 and at least two grounding portions 5, 6, the antenna of the present disclosure is rendered capable of standing on its own. Doing so makes it possible to further stabilize the antenna characteristics, particularly the impedance fluctuations.

Since the antenna is capable of standing on its own in the present disclosure, the antenna can be loaded or mounted on a substrate, more specifically a printed circuit board. This eliminates the need for a cable or other components, making it possible to achieve a smaller size. In other words, the antenna of the present disclosure can be used as a surface-mounted component.

The term “surface-mounted component” in the present disclosure means a component or member that can be mounted on a substrate such as a printed circuit board by using a surface-mount technology (SMT) that is publicly known in this technical field. The “surface-mounted component” is sometimes referred to as “surface-mounted device (SMD)”. The antenna of the present disclosure can be automatically mounted on a substrate such as a printed circuit board by SMT.

The “grounding portions” in the present disclosure may be coupled not only by surface mounting but also by engagement and/or mating with another structure serving as an ordinary terminal.

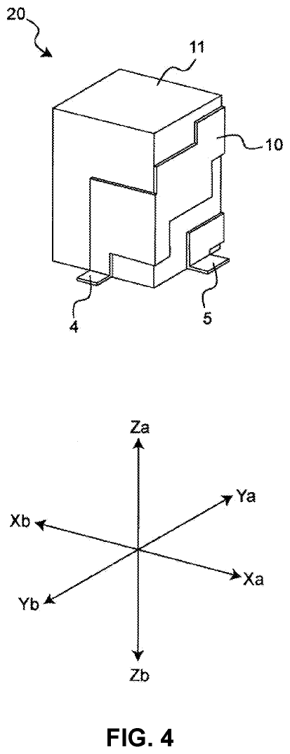

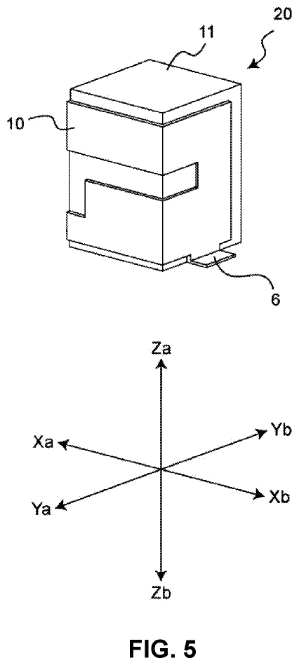

The antenna of the present disclosure may further include a supporter that may be disposed inside thereof (see FIGS. 4 to 6F, 9, and 10).

Disposing the supporter inside of the antenna makes it possible to prevent deformation of the antenna. This makes it possible to further miniaturize the antenna. Further, disposing the supporter makes it possible to further stabilize the antenna characteristics by further enhancing the shape stability and self-standing property of the antenna.

The supporter is not limited to a particular size; however, for example, in a case where the supporter has a quadrangular prismatic shape as shown in FIGS. 4 to 6F, 9, and 10, the supporter may have a size, for example, smaller than or equal to 10 mm, smaller than or equal to 6 mm, larger than or equal to 1 mm and smaller than or equal to 5 mm, on a side.

In the present disclosure, the supporter and the antenna may at least partially make contact with each other. The supporter and the antenna may be integrally coupled.

The supporter is not limited to any particular shape. For example, the supporter may have a box shape such as a cube or a cuboid or a quadrangular prismatic shape in conformance with the shape of the antenna. The supporter may have another shape such as a triangular prism, a polygonal column, or a cylinder.

At least one principal surface of the supporter may be even (or smooth or flat). The term “principal surface” of the supporter means a first principal surface that may be located at the apex of the supporter and a second principal surface that may be located at the base of the supporter.

The term “first principal surface” of the supporter means the upper face or top face of the supporter in the Za direction on which the leading end portion of the antenna of the present disclosure may be located.

The term “second principal surface” of the supporter means the lower face or bottom face of the supporter in the Zb direction on which the feeding portion and/or the grounding portions of the antenna of the present disclosure may be located.

The statement that the principal surface is “even” means that at least either the first principal surface or the second principal surface is flat and smooth (or smooth). In other words, the statement that the principal surface is “even” means that there are irregularities intentionally formed on either the first principal surface of the second principal surface.

By the principal surface of the supporter being “even”, the loading of the antenna of the present disclosure onto a plate-like structure such as a substrate can be further promoted. The first principal surface (top face) of the supporter may be even. By the first principal surface (top face) of the supporter being “even”, the antenna of the present invention can be stably mounted on a substrate or other components, for example, by surface suction.

The supporter may be composed of any material. The supporter may be composed of resin (such as polycarbonate (PC), polyphenylene sulfide (PPS), polyamide (PA), syndiotactic polystyrene (SPS), or a liquid crystal polymer (LCP)).

By disposing a dielectric substance, particularly a high dielectric substance such as a dielectric substance made of high dielectric resin, inside of the supporter, the antenna characteristics can be further stabilized. This makes it possible to further miniaturize the antenna of the present disclosure.

The antenna of the present disclosure can stably have, as the antenna characteristics, a desired frequency band or required frequency band falling within a range of, for example, 13 GHz or lower, 3 GHz to 10 GHz, 6 GHz to 9 GHz, or 6 GHz to 8.5 GHz. The antenna of the present disclosure may stably have a high frequency band of at least 6 GHz to 9 GHz and be rendered broadband.

The antenna of the present disclosure stably has an impedance falling within a range of 25Ω to 55Ω, or 45Ω to 55Ω, for example, in the desired frequency band or the required frequency band. The antenna of the present disclosure has an impedance falling within a range of 25Ω to 55Ω, or 45Ω to 55Ω, for example, in a frequency band of 13 GHz or lower, particularly 6 GHz to 9 GHz. The antenna of the present disclosure may have a targeted peak value of impedance of 50Ω in a frequency band of 6 GHz to 9 GHz. By having such a range of values of impedance, the antenna of the present disclosure can cope with ultrawideband (UWB) communication.

The antenna of the present disclosure may be multi-resonated, and is stably compatible in various resonant ranges. The antenna of the present disclosure can be high in gain and non-directional.

The antenna of the present disclosure is not limited to any particular use. Since the antenna of the present disclosure has a small size and further stabilized antenna characteristics, the antenna can be mounted in a vehicle such as an automobile, a hybrid vehicle, or an electric vehicle or an electronic device such as a smartphone or a wearable device or used in communication with such electronic devices.

Since the antenna of the present disclosure can be further miniaturized, the antenna can be disposed on a substrate inside of a computer, particularly an ECU (engine control unit), of a vehicle or a substrate inside of a smartphone or a wearable device for use.

Examples of more specific applications of the antenna of the present disclosure include utilizing the antenna Near Field Communication (NFC), high-speed communication at short range (e.g. approximately 1 m), and position detection, particularly distance measurement.

When disposed on a substrate of a computer, particularly an ECU, of a vehicle, the antenna of the present disclosure can be used, for example, in communication for protection against theft of the vehicle or automatic driving of the vehicle.

There is no particular limit on a method for manufacturing an antenna of the present disclosure. For example, in a case where the antenna of the present disclosure is manufactured from a plate-like material such as a metal or an alloy, the antenna can be simply manufactured by cutting and bending the plate-like material. Further, the plate-like material may be cut into members, and the members may be coupled by welding. In a case where the antenna of the present disclosure is manufactured from a dielectric ceramic, the antenna can be manufactured in a manner similar to that in which a chip ceramic antenna is manufactured. For example, a dielectric ceramic antenna may be formed on a heat-resistant supporter by utilizing a printing technique that is publicly known in the ceramic field.

The following describes the antenna of the present disclosure by taking some embodiments as examples, although the antenna of the present disclosure is not limited to these embodiments.

An antenna 10 according to a first embodiment of the present disclosure is shown in FIGS. 1 to 3F.

In each of the drawings, the shape of the antenna is described on the basis of an XYZ coordinate system whose Z axis is a line in a Za-Zb direction normal to an X-Y plane parallel to an X axis in an Xa-Xb direction and a Y axis in a Ya-Yb direction orthogonal to the X axis. For convenience of explanation, the Za direction is sometimes referred to as “upward”, and the Zb direction as “downward”. Further, a direction toward the center of the XYZ coordinate system is sometimes referred to as “inward direction”, and a direction away from the center as “outward direction”.

For example, as shown in FIG. 1, the antenna 10 includes a first extension portion 1, a second extension portion 2, a leading end portion 3, a feeding portion 4, a first grounding portion 5 (in the present disclosure, a grounding portion located farthest away from the feeding portion is referred to as “first grounding portion”), and a second grounding portion 6 (in the present disclosure, a grounding portion located closest to the leading end portion is referred to as “second grounding portion”). In an embodiment, the antenna 10 is manufactured from one metal plate made of a metal or an alloy, such as a brass material.

The first extension portion 1, the second extension portion 2, the leading end portion 3, the feeding portion 4, the first grounding portion 5, and the second grounding portion 6 of the antenna 10 are each not limited to any particular shape. The first extension portion 1, the leading end portion 3, and the second extension portion 2 may be successively coupled to one another to be sterically configured to have a substantially quadrangular shape in a top view. The antenna may have a boxy cubic shape as a whole (see FIGS. 3A-3F). In other words, the antenna 10 has a shape as a whole in conformance with a supporter 11 having a boxy cubic shape shown, for example, in FIGS. 4 to 6F. By having a boxy cubic shape as a whole, the antenna 10 can be made compact and smaller as a whole.

The first extension portion 1 is a portion or area that extends from the feeding portion 4 to the leading end portion 3. In the illustrated aspect, the first extension portion 1 bends at least once, and has two surfaces, namely a surface (a) parallel to an X-Z plane and a surface (b) parallel to a Z-Y plane (see FIGS. 3A-3F). Each of the surfaces (a, b) is not limited to any particular shape. In view of sending and receiving radio waves, each of the surfaces (a, b) may be constituted by a combination of a plurality of quadrangles. In other words, each of the surfaces (a, b) extend upward in stepwise from the feeding portion 4 toward the leading end portion 3. For such a reason, the first extension portion can also be referred to as “upward portion”. There is no particular limit on the number and size of surfaces that constitute the first extension portion.

The second extension portion 2 is a portion or area that extends from the leading end portion 3 to the first grounding portion 5. In the illustrated aspect, the second extension portion 2 bends at least twice, and has three surfaces, namely a surface (c) parallel to a Y-Z plane, a surface (d) parallel to the X-Z plane, and a surface (e) parallel to the Y-Z plane (see FIG. 3). Each of the surfaces (c, d, e) is not limited to any particular shape. In view of sending and receiving radio waves, each of the surfaces (c, d, e) can be constituted by a combination of a plurality of quadrangles. In other words, each of the surfaces (c, d, e) may extend downward in stepwise from the leading end portion 3 toward the first grounding portion 5. For such a reason, the second extension portion can also be referred to as “downward portion”. There is no particular limit on the number and size of surfaces that constitute the second extension portion 2.

For example, as shown in FIG. 2, the leading end portion 3 is a portion or area that is present at the highest position of the antenna in the Za direction. In the illustrated aspect, the leading end portion 3 is in the shape of a plate. The leading end portion 3 is not limited to any particular shape; however, in view of sending and receiving radio waves, the leading end portion 3 may be in the shape of a rectangular plate. There is no particular limit on the number and size of surfaces that constitute the leading end portion 3.

In a case where the leading end portion 3 is in the shape of a rectangular plate, the first extension portion 1 (specifically the surface b) and the second extension portion 2 (specifically the surface c) may be disposed at the connected portions, i.e. the short sides, respectively, of the leading end portion 3.

The feeding portion 4 may be present parallel to the X-Y plane, and may be extended in a Yb direction outward from the surface (a) of the first extension portion 1. In the illustrated aspect, the feeding portion 4 is in the shape of a plate. The feeding portion 4 is not limited to any particular shape; however, in view of being surface-mounted on a substrate or other components, it is preferable that the feeding portion 4 be in the shape of a plate having a substantially quadrangular shape such as a rectangle or a regular square in a top view. The feeding portion 4 is not limited to any particular size.

The first grounding portion 5 may be present parallel to the X-Y plane, and may be extended in an Xa direction outward from the surface (e) of the second extension portion 2. In the illustrated aspect, the first grounding portion 5 is in the shape of a plate. The first grounding portion 5 is not limited to any particular shape; however, in view of being surface-mounted on a substrate or other components and forming the ground, it is preferable that the first grounding portion 5 be in the shape of a plate having a substantially quadrangular shape such as a rectangle or a regular square in a top view. The first grounding portion 5 is not limited to any particular size.

In the present disclosure, the first grounding portion may be disposed at an angle within a range of 270 degrees or smaller in a top view with respect to the feeding portion.

For example, as shown in FIG. 2, the second grounding portion 6 may be present parallel to the X-Y plane, and may be extended in an Xb direction outward from the surface (c) of the second extension portion 2. In the illustrated aspect, the second grounding portion 6 is in the shape of a plate. The second grounding portion 6 is not limited to any particular shape; however, in view of surface mounting on a substrate or other components and forming the ground, the second grounding portion 6 may be in the shape of a plate having a substantially quadrangular shape such as a rectangle or a regular square in a top view. The second grounding portion 6 is not limited to any particular size. The antenna can be multi-resonated by thus providing the second grounding portion 6. Further, since the second grounding portion 6 may be present in the same plane (i.e. a plane parallel to the X-Y plane) as the first grounding portion 5 and the feeding portion 4, the antenna is rendered capable of standing on its own and may be more easily surface-mounted on a substrate or other components.

The surface (d) of the second extension portion 2 may further have a third grounding portion. The third extension portion may be extended in a Ya direction outward from the surface (d).

As shown in FIGS. 1 to 3F, in the antenna 10, the first extension portion 1, the leading end portion 3, and the second extension portion 2 have a steric coupling to one another. More specifically, the first extension portion 1 extends upward in the Za direction from the feeding portion 4 to the leading end portion 3 or, specifically, turns while extending upward, and the second extension portion 2 extends downward in the Zb direction from the leading end portion 3 to the first grounding portion 5 or, specifically, turns while extending downward, whereby the ground (GND) is formed. Thus, in the antenna 10, the first extension portion 1 and the second extension portion 2, integrated with the leading end portion 3, extend upward and downward while being wound in a spiral fashion, i.e. a vortical fashion, with the leading end portion 3 as an apex, whereby the antenna can be more compactly miniaturized. Such a steric configuration allows the antenna 10 to have a small size and more stable antenna characteristics (see FIG. 1).

Further, since the antenna 10 has a folded-back structure in which the leading end portion 3 and the surface (d) of the second extension portion 2 pass through the surface (c), the meandering extension of a path makes it possible to more sterically configure the antenna, and makes it possible to further miniaturize the antenna and further stabilize the antenna characteristics.

In the antenna 10, such a steric vortical or spiral folded-back structure makes it possible to more compactly design the antenna, and makes it possible to further stabilize the antenna characteristics.

The antenna of the present disclosure is not limited to any particular size; however, for example, the antenna of the present disclosure has a size, for example, smaller than or equal to mm, smaller than or equal to 6 mm, larger than or equal to 1 mm and smaller than or equal to mm, along each of the X, Y, and Z axes.

An antenna 20 according to a second embodiment of the present disclosure is shown in FIGS. 4 to 6F. The antenna 20 can be configured by disposing a supporter 11 inside of the antenna 10 (hereinafter referred to as “antenna body 10” or simply as “body 10”) of the first embodiment.

In the antenna 20, the body 10 and the supporter 11 can at least partially make contact with each other. In an embodiment, the body 10 and the supporter 11 be coupled to each other. The body 10 and the supporter 11 may be coupled to each other, for example, by engagement and/or mating. The body 10 and the supporter 11 may be coupled to each other by providing a projection extended inward from the body 10, providing the supporter 11 with a depression having a shape which is complimentary to that of the projection of the body 10, and engaging and/or mating the projection of the body 10 and the depression of the supporter 11 with each other. Alternatively, the body 10 and the supporter 11 may be coupled to each other by providing the supporter 11 with a projection and engaging and/or mating it with the body 10. More specifically, the body 10 and the supporter 11 may be engaged and/or mated with each other by providing the supporter 11 with a step. Alternatively, the supporter 11 and the body 10 may be brought into contact with and coupled to each other by the elasticity of the body 10. Alternatively, the body 10 and the supporter 11 may be coupled to each other by bonding, press-fitting, thermal caulking, or other methods.

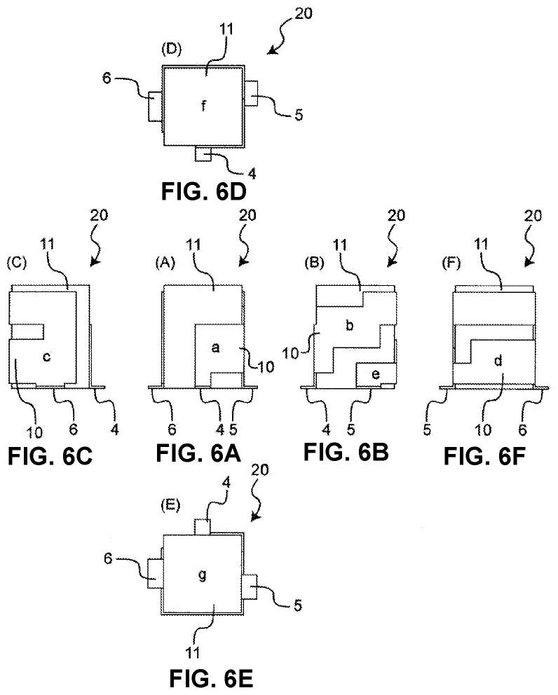

As shown in FIGS. 4 to 6F, the supporter 11 has two even principal surfaces, namely an upper, first principal surface (f) (hereinafter sometimes referred to as “top face (f)” (see FIG. 6D) and a lower, second principal surface (g) (hereinafter sometimes referred to as “bottom face (g)” (see FIG. 6E). Since the top face (f) and the bottom face (g) are even, the surface-mount technology (SMT) facilitates surface mounting on a substrate or other components, for example, by surface suction. Furthermore, SMT makes it possible to automatically mount the antenna on a substrate such as a printed circuit board together with the supporter.

The supporter 11 may have a solid or hollow interior. The supporter 11 may have a dielectric substance inside. Having a dielectric substance inside of the supporter 11 makes it possible to further miniaturize the antenna characteristics.

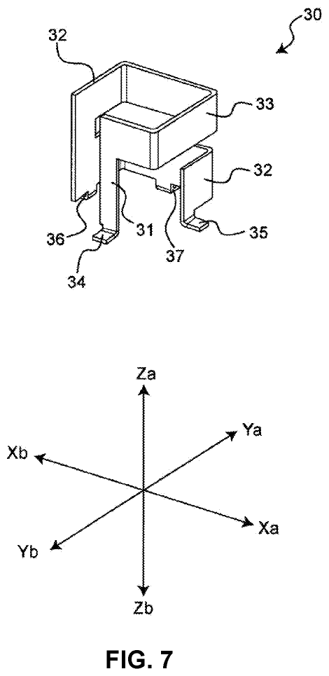

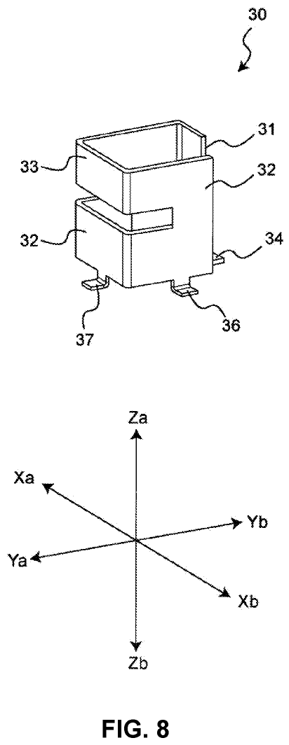

An antenna 30 according to a third embodiment of the present disclosure is shown in FIGS. 7 and 8. The antenna 30 is a variation of the antenna 10 shown in FIGS. 1 to 3F. Accordingly, the antenna 30 has a configuration which is similar to that of the antenna 10.

For example, as shown in FIGS. 7 and 8, the antenna 30 includes a first extension portion 31, a second extension portion 32, a leading end portion 33, a feeding portion 34, a first grounding portion 35, a second grounding portion 36, and a third grounding portion 37. The first extension portion 31, the second extension portion 32, the leading end portion 33, the feeding portion 34, the first grounding portion 35, and the second grounding portion 36 of the antenna 30 may correspond to the first extension portion 1, the second extension portion 2, the leading end portion 3, the feeding portion 4, the first grounding portion 5, and the second grounding portion 6 of the antenna 10 shown in FIGS. 1 to 3F, respectively.

In an embodiment, the antenna 30 is manufactured from one metal plate made of a metal or an alloy, such as a brass material.

The first extension portion 31, the second extension portion 32, the leading end portion 33, the feeding portion 34, the first grounding portion 35, the second grounding portion 36, and the third grounding portion 37 of the antenna 30 are each not limited to any particular shape.

As with the antenna 10, the antenna 30 is substantially quadrangular in top view, and has a steric vortical or spiral folded-back structure.

The first extension portion 31 is a portion or area that extends from the feeding portion 34 to the leading end portion 33. In the illustrated aspect, the first extension portion 31 has one surface, i.e. a surface parallel to the X-Z plane.

The second extension portion 32 is a portion or area that extends from the leading end portion 33 to the first grounding portion 35. In the illustrated aspect, the second extension portion 32 bends twice, and has three surfaces, i.e. two surfaces parallel to the Y-Z plane and one surface parallel to the X-Z plane.

For example, as shown in FIG. 7, the leading end portion 33 is a portion or area that is present at the highest position of the antenna in the Za direction. In the illustrated aspect, the leading end portion 33 in in the shape of a band bent in the middle. In other words, the leading end portion 33 has an elongated band-shaped surface parallel to the Y-Z plane and an elongated band-shaped surface parallel to the X-Z plane. The leading end portion 33 is not limited to any particular shape; however, in view of sending and receiving radio waves, it is preferable that the leading end portion 33 be in the shape of a band. There is no particular limit on the number and size of surfaces that constitute the leading end portion 33.

In a case where the leading end portion 33 is in the shape of a band, the first extension portion 31 and the second extension portion 32 may be disposed at the connected portions, i.e. the short sides, respectively, of the leading end portion 33.

The feeding portion 34 may be present parallel to the X-Y plane, and may be extended in the Yb direction outward from the first extension portion 31.

For example, as shown in FIG. 7, the first grounding portion 35 may be present parallel to the X-Y plane, and may be extended in the Xa direction outward from the second extension portion 32.

For example, as shown in FIG. 8, the second grounding portion 36 may be present parallel to the X-Y plane, and may be extended in the Xb direction outward from the second extension portion 32.

For example, as shown in FIG. 8, third grounding portion 37 may be present parallel to the X-Y plane, and may be extended in the Ya direction outward from the second extension portion 32. In the illustrated aspect, the third grounding portion 37 is in the shape of a plate. The third grounding portion 37 is not limited to any particular shape; however, in view of being surface-mounted on a substrate or other components and forming the ground, the third grounding portion 37 may be in the shape of a plate having a substantially quadrangular shape such as a rectangle or a regular square in a top view. The third grounding portion 37 is not limited to any particular size. Providing third grounding portion 37 makes it possible to further promote the self-standing, multi-resonation, and surface mounting of the antenna.

As shown in FIGS. 7 and 8, in the antenna 30, the first extension portion 31, the leading end portion 33, and the second extension portion 32 have a steric coupling to one another. Since the first extension portion 31 and the second extension portion 32 are each in the shape of a band as is the case with the leading end portion 33, the first extension portion 31, integrated with the leading end portion 33, can extend upward in the Za direction from the feeding portion 34 to the leading end portion 33 and the second extension portion 32, integrated with the leading end portion 33, can extend downward in the Zb direction from the leading end portion 33 to the first grounding portion 35 or, specifically, can form the ground by turning while extending downward.

The antenna 30 is simpler in structure and can therefore be further miniaturized than the antenna 10 shown in FIGS. 1 to 3F. Furthermore, since the antenna 30 has the third grounding portion 37, the antenna 30 may have further stabilized antenna characteristics as it is multi-resonated. Further, in being surface-mounted, the antenna has a further improved self-standing property.

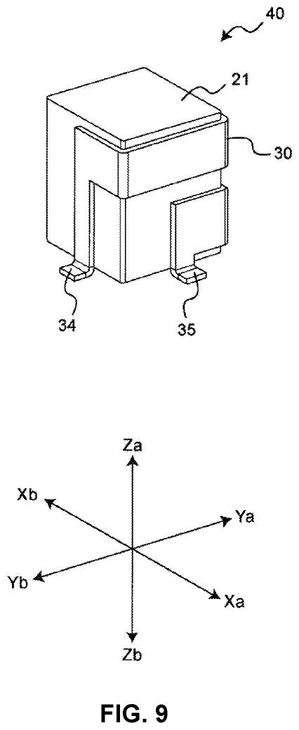

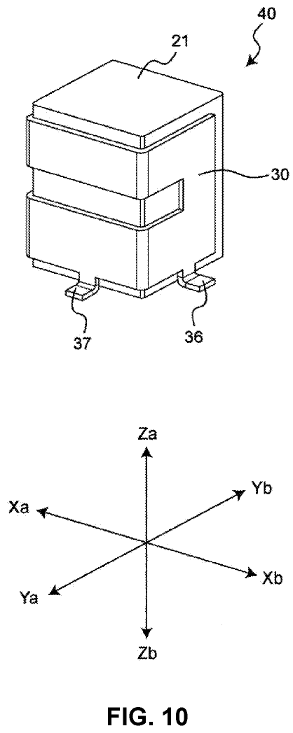

An antenna 40 according to a fourth embodiment of the present disclosure is shown in FIGS. 9 and 10. The antenna 40 can be configured by disposing a supporter 21 inside of the antenna 30 (hereinafter referred to as “antenna body 30” or simply as “body 30”) of the third embodiment. The supporter 21 can have a configuration which is similar to that of the supporter 11 shown in FIGS. 4 to 6F.

The antenna 40 according to the fourth embodiment shown in FIGS. 9 and 10 can bring about effects which are similar to those of the antenna 20 of the second embodiment shown in FIGS. 4 to 6F.

### Example 1

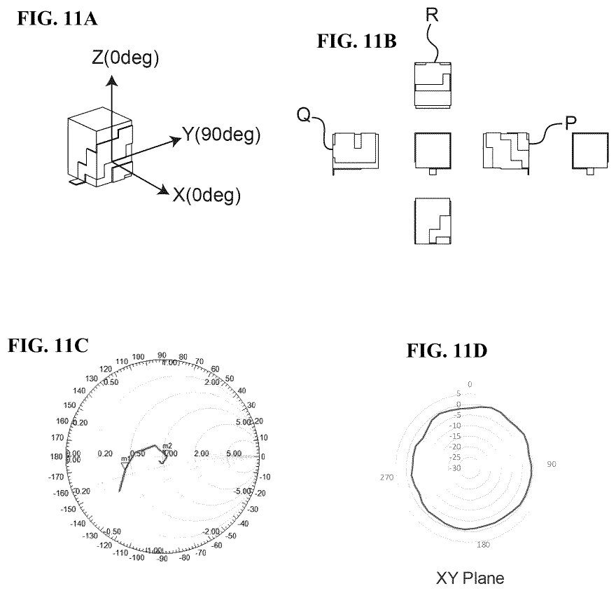

An antenna (see the isometric view of FIG. 11A and the six-side view of FIG. 11B) having a shape shown in FIGS. 11A and 11B was fabricated from a plate-like brass material (with a thickness of 0.3 mm). In FIG. 11B, the reference signs P, Q, and R denote grounding portions, respectively. The antenna fabricated in Example 1 was a monopole antenna (½λ). The antenna body had a size of 5 mm along the X axis, had a size of 5 mm along the Y axis (excluding the size of the feeding portion), and had a size (height) of 5.5 mm along the Z axis. The supporter was made of resin. The supporter had a size of 4.4 mm along the X axis, had a size of 4.4 mm along the Y axis, and had a size (height) of 5 mm along the Z axis. The impedance of the antenna fabricated in Example 1 is shown in FIG. 11C, and the directivity index (decibel (dB)) is shown in FIG. 11D as a radiating pattern.

### Comparative Example 1

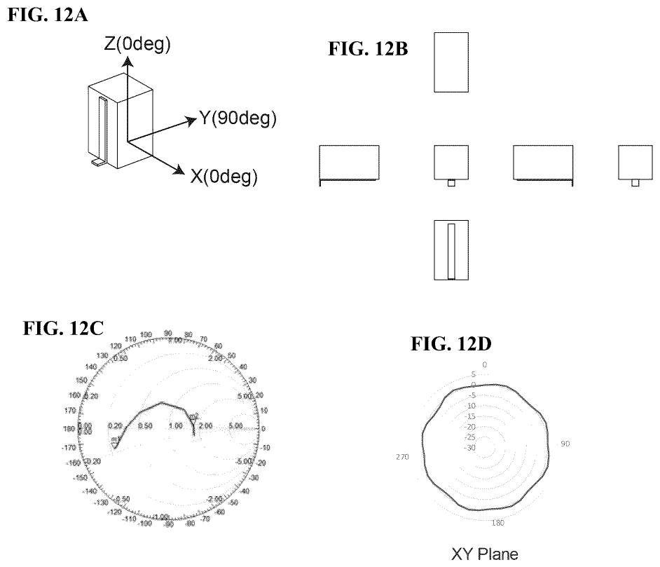

An antenna (see the isometric view of FIG. 12A and the six-side view of FIG. 12B) having a shape shown in FIG. 12 was fabricated from a plate-like brass material (with a thickness of 0.3 mm). The antenna fabricated in Comparative Example 1 was a “straight” monopole antenna (¼λ). The antenna fabricated in Comparative Example 1 had a size (width) of 2 mm along the X axis and had a size (height) of 8 mm along the Z axis. The supporter was made of resin. The supporter had a size of 5 mm along the X axis, had a size of 5 mm along the Y axis, and had a size (height) of approximately 8 mm along the Z axis. The impedance of the antenna fabricated in Comparative Example 1 is shown in FIG. 12C, and the directivity index (dB) is shown in FIG. 12D as a radiating pattern.

### Comparative Example 2

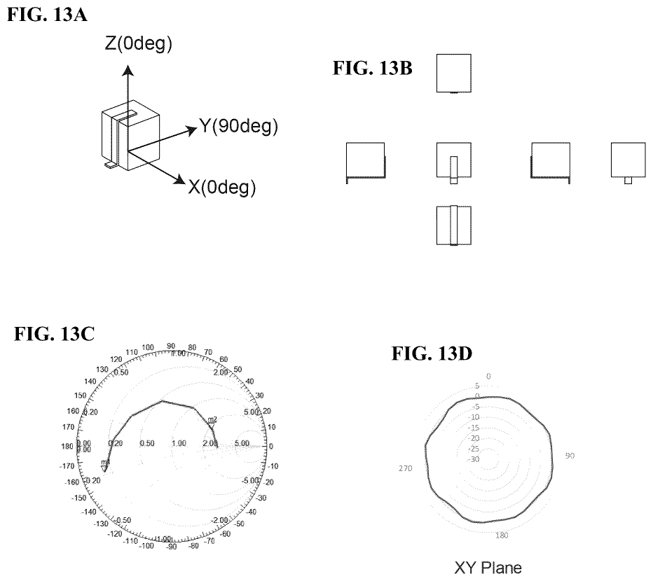

An antenna (see the isometric view of FIG. 13A and the six-side view of FIG. 13B) having a shape shown in FIG. 13 was fabricated from a plate-like brass material (with a thickness of 0.3 mm). The antenna fabricated in Comparative Example 2 was a “bent” monopole antenna (¼λ). The antenna fabricated in Comparative Example 2 had a size (width) of 2 mm along the X axis, had a size (size of a bend) of 3 mm along the Y axis (excluding the size of the feeding portion), and had a size (height) of 5.6 mm along the Z axis. The supporter was made of resin. The supporter had a size of 5 mm along the X axis, had a size of 5 mm along the Y axis, and had a size (height) of approximately 5.3 mm along the Z axis. The impedance of the antenna fabricated in Comparative Example 2 is shown in FIG. 13C, and the directivity index (dB) is shown in FIG. 13D as a radiating pattern.

### Comparative Example 3

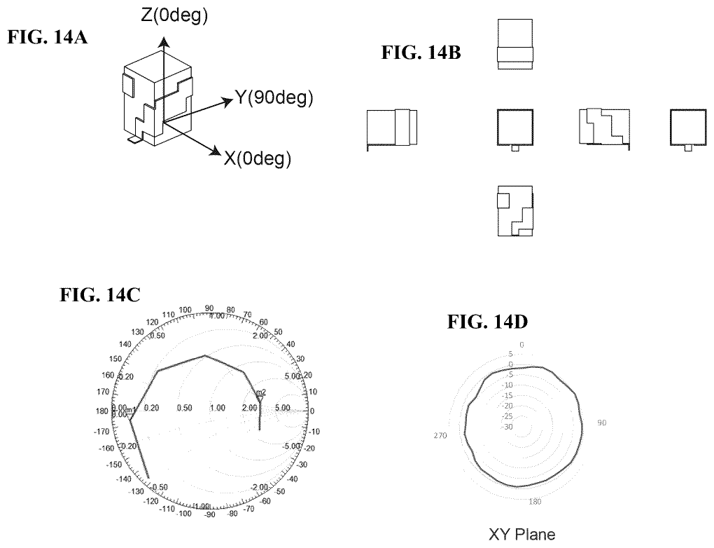

An antenna (see the isometric view of FIG. 14A and the six-side view of FIG. 14B) having a shape shown in FIG. 14 was fabricated from a plate-like brass material (with a thickness of 0.3 mm). The antenna fabricated in Comparative Example 3 was a “vortical” monopole antenna (¼λ). That is, the antenna fabricated in Comparative Example 3 is one obtained by extending the leading end portion of the antenna of Example 1 shown in FIG. 11 to the X-Z plane and cutting the leading end along the X-Z plane. The leading end portion thus extended had a size of 3 mm along the X axis in the X-Z plane. The supporter was made of resin. The supporter had a size of 4.4 mm along the X axis, had a size of 4.4 mm along the Y axis, and had a size (height) of approximately 5 mm along the Z axis. The impedance of the antenna fabricated in Comparative Example 3 is shown in FIG. 14C, and the directivity index (dB) is shown in FIG. 14D as a radiating pattern.

### Comparative Example 4

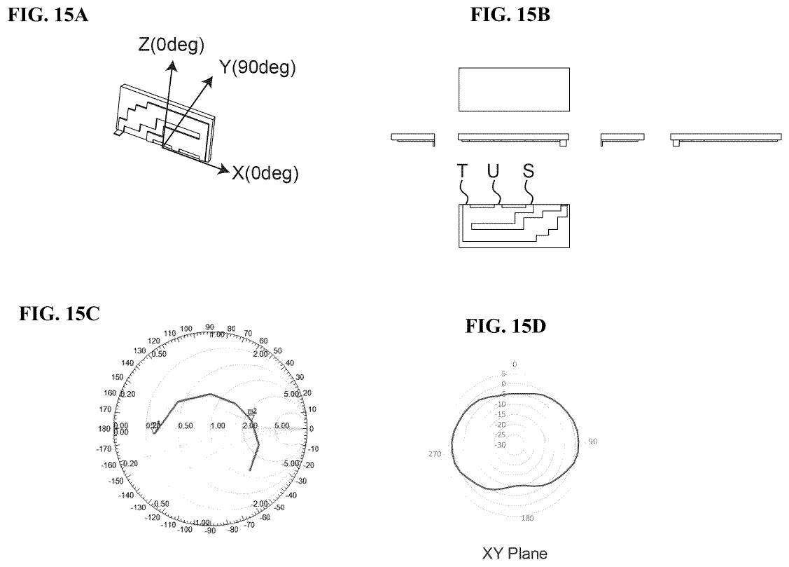

An antenna (see the isometric view of FIG. 15A and the six-side view of FIG. 15B) having a shape shown in FIG. 15 was fabricated from a plate-like brass material (with a thickness of 0.3 mm). In FIG. 15B, the reference signs S, T, and U denote grounding portions, respectively. The antenna fabricated in Comparative Example 4 was a “folded-back (switchback)” monopole antenna (½λ). The antenna fabricated in Comparative Example 4 had a size of 17 mm along the X axis (long axis) and had a size (height) of 6 mm along the Z axis. The supporter was made of resin. The supporter had a size of 20 mm along the X axis, had a size of 3 mm along the Y axis, and had a size (height) of approximately 7 mm along the Z axis. The impedance of the antenna fabricated in Comparative Example 4 is shown in FIG. 15C, and the directivity index (dB) is shown in FIG. 15D as a radiating pattern.

It was found from the directivity indices of the antennas shown in FIGS. 11 to 15D that the antenna (FIG. 11D) of Example 1 has a directivity index whose outer shape has a radiating pattern that is close to a perfect circle, and therefore has more stable antenna characteristics than the antennas fabricated in Comparative Examples 1 to 4, especially than the folded-back antenna (FIG. 15D) fabricated in Comparative Example 4, although the antenna of Example 1 is sterically and compactly miniaturized.

It should be noted that FIGS. 11 to 15C shows the impedances of the antennas of Example 1 and Comparative Examples 1 to 4, and the center of a circle indicates a targeted impedance of “50Ω”. It was found that the antenna (FIG. 11C) of Example 1 has its impedance more convergent to the center of a circle and therefore has more stable antenna characteristics than the antennas fabricated in Comparative Examples 1 to 4, especially than the vortical antenna (FIG. 14C) fabricated in Comparative Example 3, although the antenna of Example 1 is sterically and compactly miniaturized.

Furthermore, Table 1 below specifically shows the impedances of the antennas fabricated in Example 1 and Comparative Examples 1 to 4.

TABLE 1

| | | Comp. | Comp. | Comp. | Comp. |
|---|---|---|---|---|---|
| | Ex. 1 | Ex. 1 | Ex. 2 | Ex. 3 | Ex. 4 |
| LI (Ω) | 25.8 | 17.5 | 10.9 | 6.2 | 14.9 |
| HI (Ω) | 54.3 | 86.4 | 139.2 | 140.0 | 122.4 |

where LI: Low impedance, and HI: High impedance

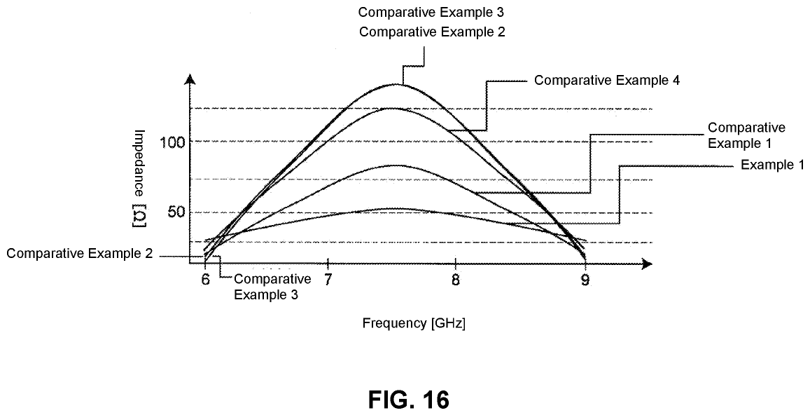

Furthermore, FIG. 16 shows relationships between the frequency [GHz] and impedance [Ω] of the antennas fabricated in Example 1 and Comparative Examples 1 to 4.

It was found that the antenna of Example 1 can more stably give a targeted impedance of approximately 50Ω, specifically an impedance of 25Ω to 55Ω, over a wide band of 6 GHz to 9 GHz than the antennas fabricated in Comparative Examples 1 to 4, although the antenna of Example 1 has a smaller size.

It was found from the above that the antenna of the present disclosure fabricated in Example 1 has further stabilized antenna characteristics over a wide band than the conventional antennas fabricated in Comparative Examples 1 to 4, although the antenna of the present disclosure fabricated in Example 1 has a smaller size.

An antenna of the present disclosure has a smaller size and more stable antenna characteristics. As well, by being thus configured, the antenna has an impedance adjustment area that is not confined to a narrow band, and is independent of a ground plate distance. Therefore, the antenna can be used more appropriately in ultrawideband (UWB) communication.

The antenna of the present disclosure can be mounted in a vehicle (such as a passenger vehicle, a hybrid vehicle, or an electric vehicle) or an electronic device (such as a smartphone or a wearable device) for use in communication and/or position detection or other applications.

The present invention has as a secondary object to provide an antenna whose impedance adjustment area is not confined to a narrow band and an antenna whose impedance adjustment area is independent of the ground plate distance.

The inventor conceived of the idea that stabilization of antenna characteristics can be attained, for example, by sterically configuring an antenna as shown in FIG. 1 to be divided into a first extension portion (1) extending or spreading from a feeding portion (4) to a leading end portion (3), the leading end portion (3) of the antenna, and a second extension portion (2) extending or spreading from the leading end portion (3) to a grounding portion (5) and, in particular, setting up a steric configuration through the utilization of a winding and/or a folding back. Further, the inventor conceived of the idea that such a configuration makes it possible to provide a plurality of grounding portions for the ground (GND) and also further stabilize the antenna characteristics through multi-resonation. Furthermore, the inventor conceived of the idea that an antenna having such a configuration, particularly an antenna including a feeding portion (4) and a plurality of grounding portions (5, 6) both of which may be extended as legs, does not require use of a coaxial cable or other components and can be more compactly designed, as such an antenna can be loaded directly, for example, on a substrate or other components.

As a result of diligent studies based on such discussions, the inventor found that an antenna can be so miniaturized as to be surface-mounted, for example, on a substrate of a computer, especially on a printed circuit board or other components, and found that antenna characteristics such as a radiating pattern and an impedance can be further stabilized.

What is claimed is:

1. An antenna, comprising:
a grounding portion;
a feeding portion;
a first extension portion extending from the feeding portion to a leading end portion of the antenna; and
a second extension portion extending from the leading end portion to the grounding portion, the first extension portion, the leading end portion, and the second extension portion have a steric coupling to one another.

2. The antenna according to claim 1, wherein the steric coupling includes a winding and/or a folding back.

3. The antenna according to claim 1, wherein the feeding portion and the grounding portion lie in a same plane.

4. The antenna according to claim 1, wherein the grounding portion is one of a pair of grounding portions.

5. The antenna according to claim 4, wherein the pair of grounding portions and the feeding portion render the antenna capable of standing on its own.

6. The antenna according to claim 1, wherein the antenna is a surface-mounted component.

7. The antenna according to claim 1, further comprising a supporter disposed inside of the antenna.

8. The antenna according to claim 7, wherein the supporter has a principal surface that is even.

9. The antenna according to claim 1, wherein the antenna has a substantially quadrangular shape in a top view.

10. The antenna according to claim 1, wherein the antenna has a resonant frequency lower than or equal to 13 GHz.

11. The antenna according to claim 10, wherein the resonant frequency of the antenna is within a range of 6 GHz to 9 GHz.

12. The antenna according to claim 1, wherein the antenna has an impedance within a range of 25 ohms to 55 ohms.

13. The antenna according to claim 1, wherein the antenna is independent of a ground plate distance.

14. The antenna according to claim 1, wherein the antenna is for use in a vehicle or an electronic device.
